(19) United States
(12) Patent Application Publication
(10) Pub. No.: US 2005/0211513 A1
(43) Pub. Date: Sep. 29, 2005

(54) Brake friction material

(76) Inventors: Katsuya Okayama, Kariya-shi (JP); Hiroyuki Fujikawa, Kariya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/083,315

(22) Filed: Mar. 18, 2005

(30) Foreign Application Priority Data
Mar. 24, 2004 (JP) 2004-087665

(51) Int. Cl. F16D 69/00

(52) U.S. Cl. 188/251 A

(57) ABSTRACT

A brake friction material, which is pressed against a disc rotor formed of an iron-based material, contains a reinforcing fiber, a friction-controlling material, and a filler, which are bonded together with a binder resin. The brake friction material further contains iron oxide particles having a particle size of 0.5 μm or less in an amount of 1 to 30 vol %. When the brake friction material comes into surface contact with an iron-made disc rotor under non-braking conditions, an iron oxide protective film can be formed on the friction surface of the disc rotor through reaction between the iron oxide contained in the friction material and iron constituting the disc rotor. Therefore, grinding of the disc rotor by the grinding component of the brake friction material can be suppressed.

### BACKGROUND OF THE INVENTION

1. Field of the Invention

The present invention relates to a friction material for use in, for example, a brake pad of a disc brake (hereinafter such a friction material may be referred to as a “brake friction material”); and more particularly to a brake friction material which is pressed against a disc rotor formed of an iron-based material (e.g., cast iron or stainless steel).

2. Background Art

Such a brake friction material is disclosed in, for example, Japanese Patent Application Laid-Open (kokai) No. 8-85781. The brake friction material disclosed in this patent document contains a reinforcing fiber, a friction-controlling material, and a filler, which are bonded together with a binder resin.

The brake friction material disclosed in this patent document further contains magnetite (Fe₃O₄) particles having a particle size of 1 to 100 μm in an amount of 1 to 50 vol %. Although the brake friction material can exhibit effects as described in the patent document, magnetite contained therein exerts greater grinding than necessary, causing an unnecessary increase in disc thickness variation (abbreviated as “DTV”) of a disc rotor, which variation is attributed to, for example, an inclination of the rotor. The present inventors have found that such an increase in DTV may cause brake vibration.

The aforementioned DTV is produced and increases as follows. Specifically, as schematically shown in FIG. 1, when a disc rotor 11 is inclined (inclination angle θ and deviation amount S are shown in an exaggerated manner in FIG. 1) during the course of driving under non-braking conditions, a brake friction material 12a of an inner pad 12 and a brake friction material 13a of an outer pad 13 respectively come into light contact with friction surfaces 11a and 11b of the disc rotor 11 at very low pressure, as compared with the case of driving under braking conditions, and the contact portions of the surfaces 11a and 11b are ground by the brake friction materials 12a and 13a of the pads 12 and 13, respectively, as shown by reference letters G1 and G2 of FIGS. 2 through 4, resulting in an increase in DTV. The DTV is generally represented by the difference between the maximum thickness To and the minimum thickness T1 or T2 of the disc rotor 11 shown in FIG. 2.

### SUMMARY OF THE INVENTION

The present invention has been accomplished on the basis of the above-described finding. An object of the present invention is to provide a brake friction material which, when coming into light contact with a disc rotor formed of an iron-based material, causes virtually no grinding of the rotor, which exhibits a sufficiently high friction coefficient (μ) during the course of braking, and which, even when used at high temperature, exhibits almost the same friction coefficient (μ) and maintains its braking effects.

In order to attain the aforementioned object, the present invention provides a brake friction material which, in use, is pressed against a disc rotor formed of an iron-based material, the brake friction material comprising: a reinforcing fiber; a friction-controlling material; a filler; a binder resin; and iron oxide particles having a particle size of 0.5 μm or less, wherein the reinforcing fiber, the friction-controlling material, the filler, and the iron oxide particles are bonded together with the binder resin, and the amount of the iron oxide particles is 1 to 30 vol % with respect to the volume of the brake friction material. The iron oxide contained in the brake friction material may be in the form of Fe₂O₃ or Fe₃O₄.

Since the brake friction material contains fine iron oxide particles having a particle size of 0.5 μm or less in an amount of 1 to 30 vol %, deterioration of the moldability of the friction material can be suppressed (when the amount of iron oxide contained in the brake friction material exceeds 30 vol %, the moldability of the material is deteriorated), and, when the friction material comes into surface contact with an iron-made disc rotor under non-braking conditions (at low pressure), an iron oxide protective film can be formed on the friction surface of the disc rotor through reaction between the iron oxide contained in the friction material and iron constituting the disc rotor.

Therefore, grinding of the disc rotor by the grinding component of the brake friction material can be suppressed, and thus the amount of DTV in the disc rotor can be reduced without lowering of the friction coefficient (μ) of the brake friction material. The aforementioned iron oxide protective film, which has a thickness of about 1 μm and assumes a black color, can be visually observed.

In the present invention, preferably, the particle size of the iron oxide particles contained in the brake friction material is 0.1 to 0.4 μm. When the particle size falls within this preferred range; i.e., when iron oxide particles having a particle size of less than 0.1 μm (such particles require high production cost and pose problems in terms of handling or stability thereof) are not employed, the brake friction material can be readily produced at low cost. Meanwhile, when the iron oxide particles contained in the brake friction material have a particle size of 0.4 μm or less, grinding of a disc rotor by the particles can be suppressed, and thus the amount of DTV in the disc rotor can be reduced.

In the present invention, preferably, the amount of the iron oxide particles contained in the brake friction material is 2.5 to 20 vol %. When the amount falls within this preferred range, the moldability of the brake friction material can be maintained at a high level, and the amount of DTV in a disc rotor can be reduced.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with accompanying drawings, in which:

FIG. 1 is a front view of a disc brake, which schematically shows the mechanism by which DTV occurs;

FIG. 2 is a front view showing a disc rotor with DTV;

FIG. 3 is a side view showing the inner side of the disc rotor of FIG. 2; and

FIG. 4 is a side view showing the outer side of the disc rotor of FIG. 2.

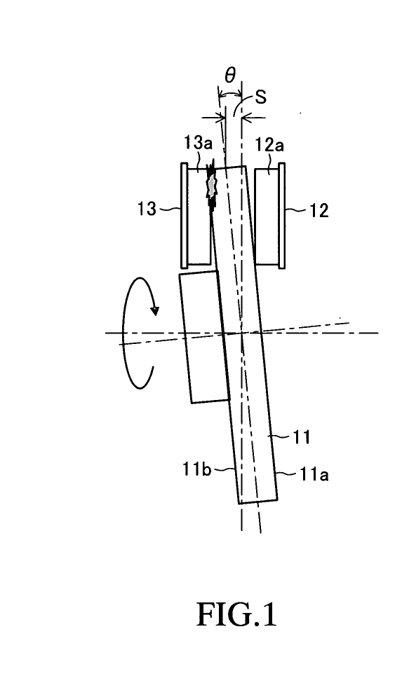

### DETAILED DESCRIPTION OF PREFERRED EMBODIMENTS

In order to confirm the above-described effects of the present invention, brake friction materials of Examples 1 through 16 and Comparative Examples 1 through 15 shown in Tables 1 and 2 were prepared, and the thus-prepared brake friction materials were evaluated by means of evaluation methods A, B, and C shown in Tables 1 and 2. The comprehensive evaluation D of each of the brake friction materials was performed on the basis of the results of the evaluation methods A, B, and C. Table 1 shows the results in the case where the iron oxide contained in the brake friction materials is Fe₂O₃, and Table 2 shows the results in the case where the iron oxide contained in the brake friction materials is Fe₃O₄.

TABLE 1

| | | | | Braking | Braking | | |
|---|---|---|---|---|---|---|---|
| | | | | effect | effect | Moldability | |
| | | | Increase | (friction | (friction | of friction | Comprehensive |
| | | | in DTV | coefficient): | coefficient): | material | evaluation |
| | | | during | before | after used | (Four-point- | (Four-point- |
| Fe₂O₃ | Particle | | testing | used at high | at high | scale | scale |
| Evaluation | size | Amount | (μm) | temperature | temperature | evaluation) | evaluation) |
| method | (μm) | (vol %) | A | B | B | C | D |
| Comp. Ex. 1 | — | 0 | 27 | 0.411 | 0.401 | AA | DD |
| Ex. 1 | 0.1 | 1 | 19 | 0.412 | 0.409 | AA | BB |
| Ex. 2 | | 2.5 | 16 | 0.414 | 0.411 | AA | AA |
| Ex. 3 | | 20 | 11 | 0.422 | 0.420 | BB | AA |
| Ex. 4 | | 30 | 7 | 0.429 | 0.422 | CC | BB |
| Comp. Ex. 2 | | 35 | 5 | 0.430 | 0.427 | DD | DD |
| Ex. 5 | 0.2 | 1 | 20 | 0.413 | 0.411 | AA | BB |
| Ex. 6 | | 2.5 | 16 | 0.416 | 0.414 | AA | AA |
| Ex. 7 | | 20 | 12 | 0.423 | 0.421 | BB | AA |
| Ex. 8 | | 30 | 8 | 0.431 | 0.430 | CC | BB |
| Comp. Ex. 3 | | 35 | 7 | 0.432 | 0.430 | DD | DD |
| Ex. 9 | 0.4 | 1 | 20 | 0.416 | 0.414 | AA | BB |
| Ex. 10 | | 2.5 | 19 | 0.419 | 0.417 | AA | AA |
| Ex. 11 | | 20 | 14 | 0.424 | 0.422 | BB | AA |
| Ex. 12 | | 30 | 12 | 0.432 | 0.429 | CC | BB |
| Comp. Ex. 4 | | 35 | 11 | 0.436 | 0.430 | DD | DD |
| Ex. 13 | 0.5 | 1 | 24 | 0.417 | 0.415 | AA | CC |
| Ex. 14 | | 2.5 | 23 | 0.421 | 0.419 | AA | BB |
| Ex. 15 | | 20 | 24 | 0.430 | 0.428 | BB | CC |
| Ex. 16 | | 30 | 24 | 0.439 | 0.436 | CC | CC |
| Comp. Ex. 5 | | 35 | 26 | 0.440 | 0.439 | DD | DD |
| Comp. Ex. 6 | 0.7 | 1 | 29 | 0.419 | 0.417 | AA | DD |
| Comp. Ex. 7 | | 2.5 | 30 | 0.422 | 0.419 | AA | DD |
| Comp. Ex. 8 | | 20 | 30 | 0.433 | 0.431 | AA | DD |
| Comp. Ex. 9 | | 30 | 31 | 0.440 | 0.437 | CC | DD |
| Comp. Ex. 10 | | 35 | 34 | 0.442 | 0.439 | DD | DD |
| Comp. Ex. 11 | 1.0 | 1 | 31 | 0.420 | 0.419 | AA | DD |
| Comp. Ex. 12 | | 2.5 | 34 | 0.423 | 0.421 | AA | DD |
| Comp. Ex. 13 | | 20 | 35 | 0.435 | 0.431 | AA | DD |
| Comp. Ex. 14 | | 30 | 37 | 0.443 | 0.440 | BB | DD |
| Comp. Ex. 15 | | 35 | 41 | 0.445 | 0.442 | DD | DD |
| Evaluation | | | | | | AA: Very | AA: Very good |
| criteria | | | | | | good | |
| | | | | | | BB: Good | BB: Good |
| | | | | | | CC: Usable | CC: Usable |
| | | | | | | DD: | DD: Unusable |
| | | | | | | Unusable | |

TABLE 2

| | | | | Braking | Braking | | |
|---|---|---|---|---|---|---|---|
| | | | | effect | effect | Moldability | |
| | | | Increase | (friction | (friction | of friction | Comprehensive |
| | | | in DTV | coefficient): | coefficient): | material | evaluation |
| | | | during | before used | after used | (Four-point- | (Four-point- |
| Fe₃O₄ | Particle | | testing | at high | at high | scale | scale |
| Evaluation | size | Amount | (μm) | temperature | temperature | evaluation) | evaluation) |
| method | (μm) | (vol %) | A | B | B | C | D |
| Comp. Ex. 1 | — | 0 | 27 | 0.411 | 0.401 | AA | DD |
| Ex. 1 | 0.1 | 1 | 20 | 0.412 | 0.409 | AA | BB |
| Ex. 2 | | 2.5 | 16 | 0.414 | 0.411 | AA | AA |
| Ex. 3 | | 20 | 12 | 0.422 | 0.420 | BB | AA |
| Ex. 4 | | 30 | 7 | 0.429 | 0.422 | CC | BB |
| Comp. Ex. 2 | | 35 | 6 | 0.430 | 0.427 | DD | DD |
| Ex. 5 | 0.2 | 1 | 20 | 0.413 | 0.411 | AA | BB |
| Ex. 6 | | 2.5 | 17 | 0.416 | 0.414 | AA | AA |
| Ex. 7 | | 20 | 13 | 0.423 | 0.421 | BB | AA |
| Ex. 8 | | 30 | 8 | 0.431 | 0.430 | CC | BB |
| Comp. Ex. 3 | | 35 | 7 | 0.432 | 0.430 | DD | DD |
| Ex. 9 | 0.4 | 1 | 21 | 0.416 | 0.414 | AA | BB |
| Ex. 10 | | 2.5 | 19 | 0.419 | 0.417 | AA | AA |
| Ex. 11 | | 20 | 14 | 0.424 | 0.422 | BB | AA |
| Ex. 12 | | 30 | 12 | 0.432 | 0.429 | CC | BB |
| Comp. Ex. 4 | | 35 | 12 | 0.436 | 0.430 | DD | DD |
| Ex. 13 | 0.5 | 1 | 25 | 0.417 | 0.415 | AA | CC |
| Ex. 14 | | 2.5 | 23 | 0.421 | 0.419 | AA | BB |
| Ex. 15 | | 20 | 24 | 0.430 | 0.428 | BB | CC |
| Ex. 16 | | 30 | 24 | 0.439 | 0.436 | CC | CC |
| Comp. Ex. 5 | | 35 | 26 | 0.440 | 0.439 | DD | DD |
| Comp. Ex. 6 | 0.7 | 1 | 29 | 0.419 | 0.417 | AA | DD |
| Comp. Ex. 7 | | 2.5 | 29 | 0.422 | 0.419 | AA | DD |
| Comp. Ex. 8 | | 20 | 30 | 0.433 | 0.431 | AA | DD |
| Comp. Ex. 9 | | 30 | 31 | 0.440 | 0.437 | CC | DD |
| Comp. Ex. 10 | | 35 | 33 | 0.442 | 0.439 | DD | DD |
| Comp. Ex. 11 | 1.0 | 1 | 31 | 0.420 | 0.419 | AA | DD |
| Comp. Ex. 12 | | 2.5 | 33 | 0.423 | 0.421 | AA | DD |
| Comp. Ex. 13 | | 20 | 34 | 0.435 | 0.431 | AA | DD |
| Comp. Ex. 14 | | 30 | 37 | 0.443 | 0.440 | BB | DD |
| Comp. Ex. 15 | | 35 | 40 | 0.445 | 0.442 | DD | DD |
| Evaluation | | | | | | AA: Very | AA: Very good |
| criteria | | | | | | good | |
| | | | | | | BB: Good | BB: Good |
| | | | | | | CC: Usable | CC: Usable |
| | | | | | | DD: | DD: Unusable |
| | | | | | | Unusable | |

The brake friction material of Comparative Example 1 shown in Table 1 is the same as that of Comparative Example 1 shown in Table 2. The brake friction material of Comparative Example 1 is an example of a non-asbestos friction material containing one or more reinforcing fibers selected from among an inorganic fiber, an organic fiber, and a metallic fiber, a friction-controlling material (e.g., barium sulfate), and a filler (e.g., cashew dust), wherein the reinforcing fibers, the friction-controlling material, and the filler are bonded together with a thermosetting binder resin (e.g., phenolic resin). The raw materials (components) of the brake friction material, and the amounts (vol %) of the components are shown in Table 3. The brake friction material, which has an iron oxide content (vol %) represented by “x” of zero, is an example of a base material having a high friction coefficient.

TABLE 3

| Raw materials | Components | Vol % |
|---|---|---|
| Reinforcing fiber | Aramid fiber | 10 |
| | Copper fiber | 5 |
| | Ceramic fiber | 10 |
| Friction-controlling | Graphite | 5 |
| material and filler | Cashew dust | 5 |
| | Calcium hydroxide | 2 |
| | Barium sulfate | 43 − x |
| Binder | Phenolic resin | 20 |
| Iron oxide | | x |
| Total | | 100 |

The brake friction materials of Examples 1 through 16 shown in Tables 1 and 2 contain iron oxide particles having a particle size of 0.1 μm, 0.2 μm 0.4 μm, or 0.5 μm in an amount of 1 vol %, 2.5 vol %, 20 vol %, or 30 vol %. Each of the brake friction materials contains, in addition to iron oxide and barium sulfate whose content varies with the iron oxide content, the components of the base material shown in Table 3 in the same amounts (vol %) as those described above.

The brake friction materials of Comparative Examples 2 through 5 shown in Tables 1 and 2 contain iron oxide particles having a particle size of 0.1 μm, 0.2 μm, 0.4 μm, or 0.5 μm in an amount of 35 vol %. Each of the brake friction materials contains, in addition to iron oxide and barium sulfate whose content varies with the iron oxide content, the components of the base material shown in Table 3 in the same amounts (vol %) as those described above.

The brake friction materials of Comparative Examples 6 through 15 shown in Tables 1 and 2 contain iron oxide particles having a particle size of 0.7 μm or 1.0 μm in an amount of 1 vol %, 2.5 vol %, 20 vol %, 30 vol %, or 35 vol %. Each of the brake friction materials contains, in addition to iron oxide and barium sulfate whose content varies with the iron oxide content, the components of the base material shown in Table 3 in the same amounts (vol %) as those described above.

Each of the brake friction materials of Examples 1 through 16 and Comparative Examples 1 through 15 shown in Tables 1 and 2 was prepared through the following procedure: the aforementioned raw materials were uniformly mixed together by use of Eirich mixer; the resultant mixture (150 g) was placed in a mold which had been heated to 160° C.; a pressure of 200 kg/cm² was applied thereto for 10 minutes, to thereby mold the mixture and bond it to a back-plate; and the thus-molded product was heated at 230° C. for three hours so as to cure the binder resin, thereby yielding a brake friction material (brake pads for a disc brake).

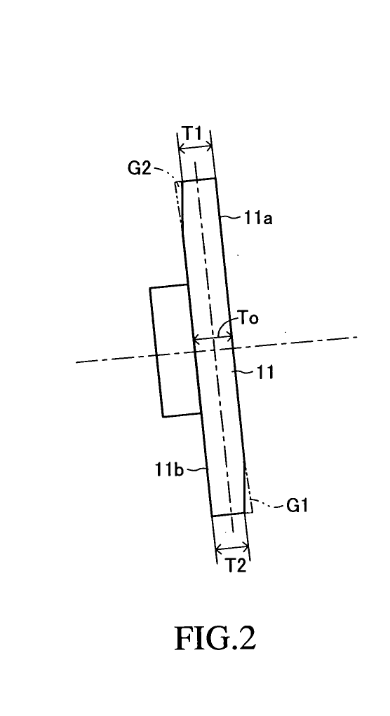

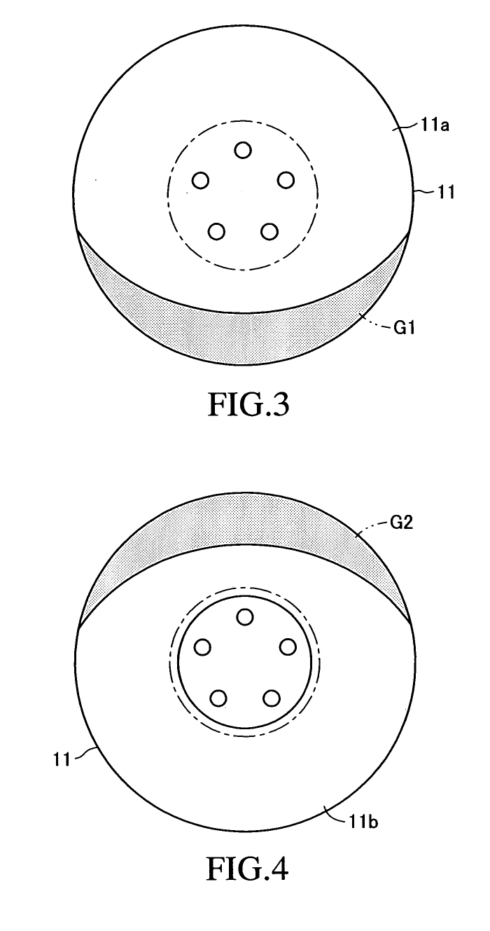

The aforementioned evaluation method A shown in Tables 1 and 2 was performed by use of a bench testing machine. The initial deviation amount S (see FIG. 2) of a disc rotor of a brake system was set to 100 μm. The brake system was subjected to the following test cycle: the brake friction material is brought into slide contact with the disc rotor 50 times (65 to 0 km/h, deceleration: 3.5 m/s², pad temperature before braking: 90° C.); the disc rotor is rotated under non-braking conditions at a speed of 100 km/h for one hour; and the disk rotor is braked (from 100 to 60 km/h) 10 times in a consecutive manner. This test cycle was carried out 30 times, and the difference in DTV between the disc rotor before the test and the disc rotor after the test was evaluated as an increase in DTV (μm).

In the evaluation method B, bench testing was performed according to JASO-C406-82, and the average of friction coefficients of the brake friction material before and after fading was calculated. In the evaluation method C, moldability of the brake friction material was evaluated on a four-point scale through visual observation of cracking of the brake friction material. The comprehensive evaluation D was performed on the basis of comparison in DTV and friction coefficient between the target brake friction material and the brake friction material of Comparative Example 1, and on the basis of moldability of the target brake friction material.

The present invention has been described by way of Examples 1 through 16, each of which employs a non-asbestos friction material (base material) formed of raw materials (components) shown in Table 3 (i.e., one or more reinforcing fibers selected from among an inorganic fiber, an organic fiber, and a metallic fiber, a friction-controlling material (e.g., barium sulfate), and a filler (e.g., cashew dust), which are bonded together with a thermosetting binder resin (e.g., phenolic resin)), the amounts of these raw materials being shown in Table 3. However, the present invention is not limited to these examples, and the invention may be applied to various non-asbestos friction materials other than those shown in Table 3, with or without appropriate modifications.

1. A brake friction material which, in use, is pressed against a disc rotor formed of an iron-based material, the brake friction material comprising:
a reinforcing fiber;
a friction-controlling material;
a filler;
a binder resin; and
iron oxide particles having a particle size of 0.5 μm or less, wherein the reinforcing fiber, the friction-controlling material, the filler, and the iron oxide particles are bonded together with the binder resin, and the amount of the iron oxide particles is 1 to 30 vol % with respect to the volume of the brake friction material.

2. A brake friction material according to claim 1, wherein the particle size of the iron oxide particles is 0.1 to 0.4 μm.

3. A brake friction material according to claim 1, wherein the amount of the iron oxide particles is 2.5 to 20 vol % with respect to the volume of the brake friction material.

4. A brake friction material according to claim 2, wherein the amount of the iron oxide particles is 2.5 to 20 vol % with respect to the volume of the brake friction material.
